(19) United States
(12) Patent Application Publication
(10) Pub. No.: US 2026/0223045 A1
(43) Pub. Date: Jul. 30, 2026

(54) POSITION ACCURACY IMPROVEMENTS THROUGH CROWDSOURCING

(71) Applicant: QUALCOMM Incorporated, San Diego, CA (US)

(72) Inventors: Varun Amar REDDY, San Diego, CA (US); Alexandros MANOLAKOS, Athens (GR); Krishna Kiran MUKKAVILLI, San Diego, CA (US); Jonathan PETIT, Wenham, MA (US); Dan VASSILOVSKI, Del Mar, CA (US); Bala RAMASAMY, San Marcos, CA (US)

(21) Appl. No.: 19/145,603

(22) PCT Filed: Nov. 28, 2023
(86) PCT No.: PCT/US2023/081397

§ 371 Date: Jul. 3, 2025

(30) Foreign Application Priority Data
Jan. 19, 2023 (GR) 20230100038

(51) Int. Cl. H04W 64/00

(52) U.S. Cl. CPC H04W 64/00

(57) ABSTRACT

Disclosed are techniques for wireless communication. In an aspect, a first wireless device may receive, from a second wireless device, a first message, the first message comprising an advertised location of the second wireless device (910). The wireless device may determine an estimated location of the second wireless device (920). The wireless device may detect a discrepancy between the advertised location of the second wireless device and the estimated location of the second wireless device (930). The wireless device may send, to at least one other wireless device, a second message, the second message indicating that there is a discrepancy between the advertised location of the second wireless device and the estimated location of the second wireless device (940).

### BACKGROUND OF THE DISCLOSURE

### 1. Field of the Disclosure

Aspects of the disclosure relate generally to wireless positioning.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)) and other technical enhancements.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a first wireless device includes receiving, from a second wireless device, a first message, the first message comprising an advertised location of the second wireless device; determining an estimated location of the second wireless device; detecting a discrepancy between the advertised location of the second wireless device and the estimated location of the second wireless device; and sending, to at least one other wireless device, a second message, the second message indicating that there is a discrepancy between the advertised location of the second wireless device and the estimated location of the second wireless device.

In an aspect, a method of wireless communication performed by a first wireless device includes transmitting a first message, the first message comprising an advertised location of the first wireless device; and receiving, from a second wireless device, a second message, the second message indicating that there is a discrepancy between the advertised location of the first wireless device and an estimated location of the first wireless device.

In an aspect, a method of wireless communication performed by a network entity includes monitoring a network for messages related to positioning; and detecting positioning misbehavior based on contents of the messages related to positioning.

In an aspect, a method of wireless communication performed by a wireless device includes determining a set of weights to be applied to sources of positioning information; and transmitting the set of weights to one or more other wireless devices.

In an aspect, a first wireless device includes a memory; at least one transceiver; and at least one processor communicatively coupled to the memory and the at least one transceiver, the at least one processor configured to: receive, from a second wireless device via the at least one transceiver, a first message, the first message comprising an advertised location of the second wireless device; determine an estimated location of the second wireless device; detect a discrepancy between the advertised location of the second wireless device and the estimated location of the second wireless device; and send, to at least one other wireless device via the at least one transceiver, a second message, the second message indicating that there is a discrepancy between the advertised location of the second wireless device and the estimated location of the second wireless device.

In an aspect, a first wireless device includes a memory; at least one transceiver; and at least one processor communicatively coupled to the memory and the at least one transceiver, the at least one processor configured to; transmit, via the at least one transceiver, a first message, the first message comprising an advertised location of the first wireless device; and receive, from a second wireless device via the at least one transceiver, from a second wireless device, a second message, the second message indicating that there is a discrepancy between the advertised location of the first wireless device and an estimated location of the first wireless device.

In an aspect, a network entity includes a memory; at least one transceiver; and at least one processor communicatively coupled to the memory and the at least one transceiver, the at least one processor configured to: monitor a network for messages related to positioning; and detect positioning misbehavior based on contents of the messages related to positioning.

In an aspect, a wireless device includes a memory; at least one transceiver; and at least one processor communicatively coupled to the memory and the at least one transceiver, the at least one processor configured to: determine a set of weights to be applied to sources of positioning information; and transmit, via the at least one transceiver, the set of weights to one or more other wireless devices.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 is a diagram illustrating various downlink channels within an example downlink slot, according to aspects of the disclosure.

FIG. 6 is a diagram illustrating various uplink channels within an example uplink slot, according to aspects of the disclosure.

FIG. 7 illustrates an example of a wireless communications system that supports unicast sidelink establishment, according to aspects of the disclosure.

FIG. 8 illustrates possible interactions between a wireless devices, according to aspects of the disclosure.

FIG. 9 is a flowchart of an example process, performed by a wireless device, associated with position accuracy improvements through crowdsourcing, according to aspects of the disclosure.

FIG. 10 is a flowchart of an example process, performed by a wireless device, associated with position accuracy improvements through crowdsourcing, according to aspects of the disclosure.

FIG. 11 is a flowchart of an example process, performed by a network entity, associated with position accuracy improvements through crowdsourcing, according to aspects of the disclosure.

FIG. 12 is a flowchart of an example process, performed by a wireless device, associated with position accuracy improvements through crowdsourcing, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

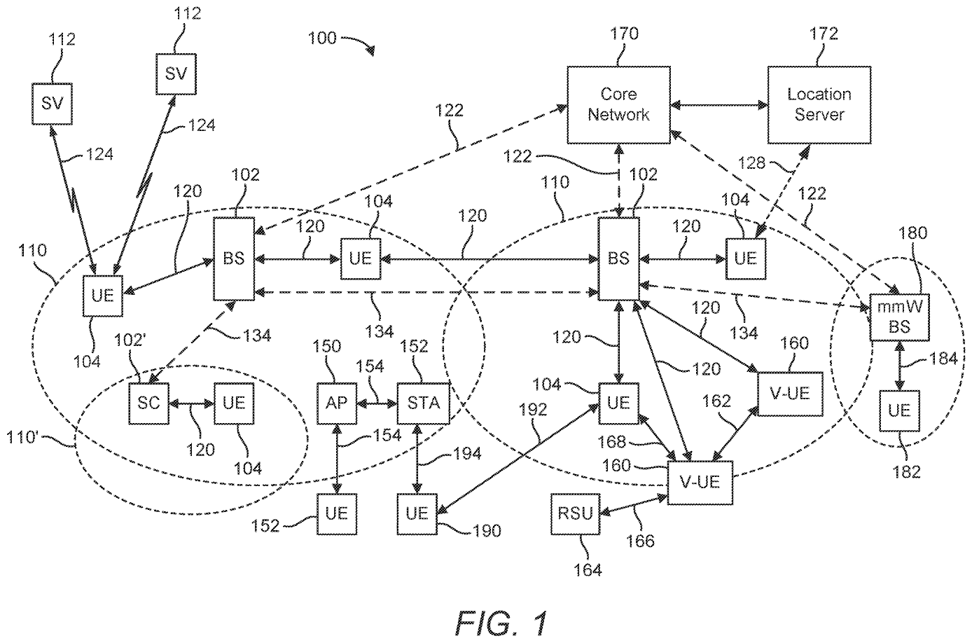

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen-before-talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHZ. Other bands may be allocated in other countries. Thus, as a particular example, the medium of interest utilized by sidelinks 162, 166, 168 may correspond to at least a portion of the licensed ITS frequency band of sub-6 GHZ. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHZ (5.85-5.925 GHz) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHz.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on. As another example, the D2D P2P links 192 and 194 may be sidelinks, as described above with reference to sidelinks 162, 166, and 168.

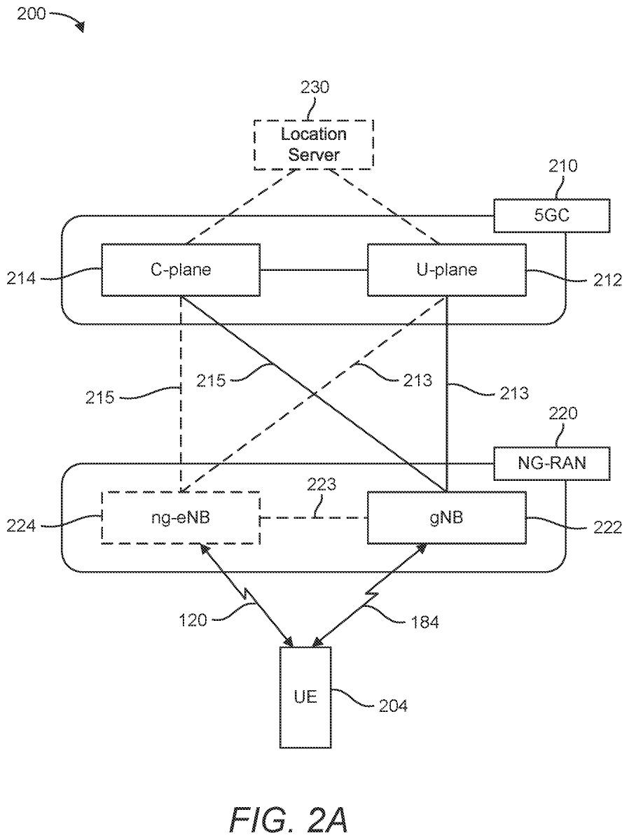

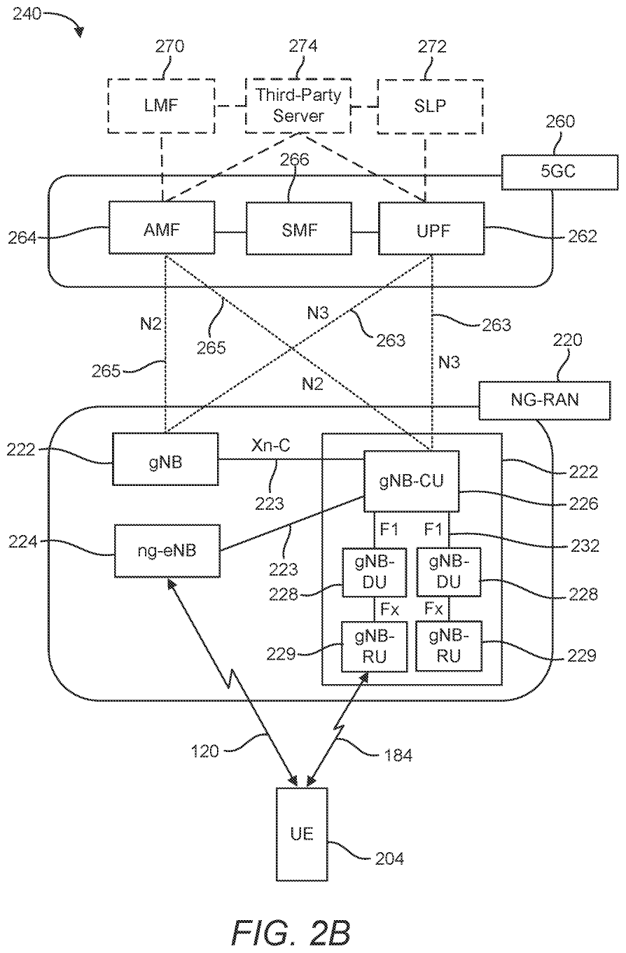

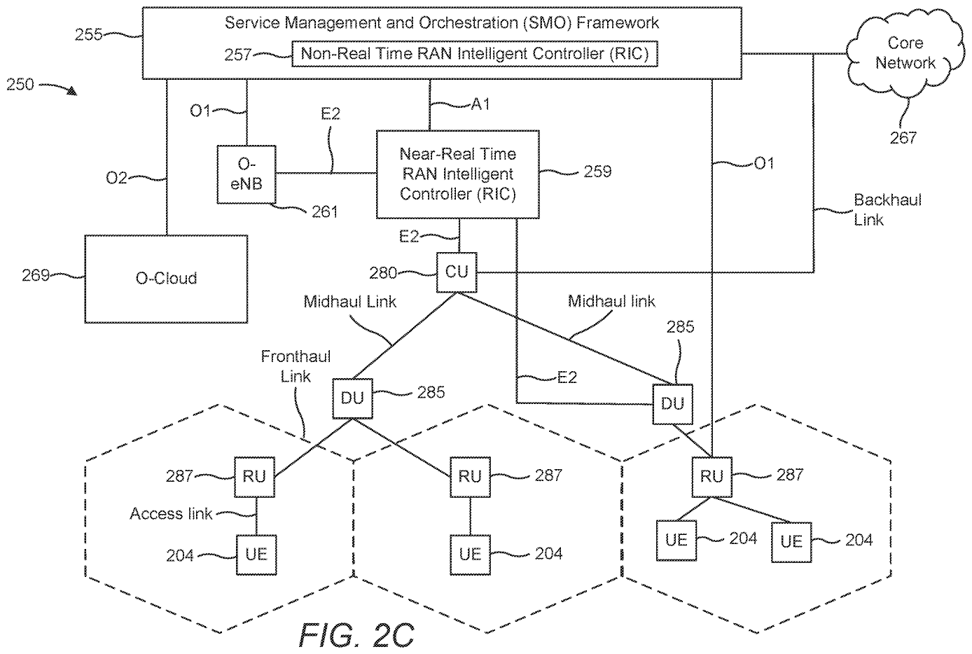

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (@NB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network. 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more distributed units (DUs) 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 280 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

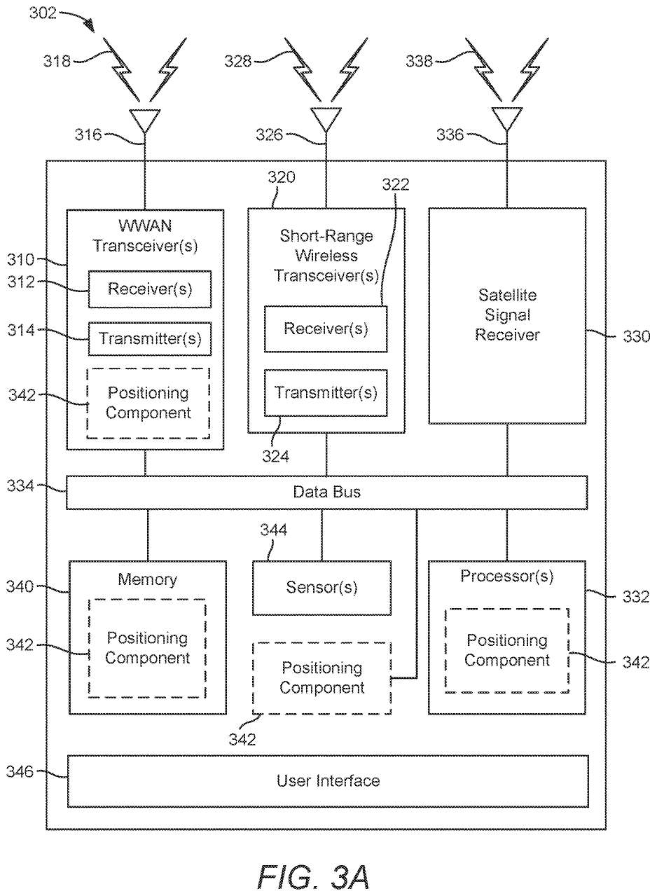

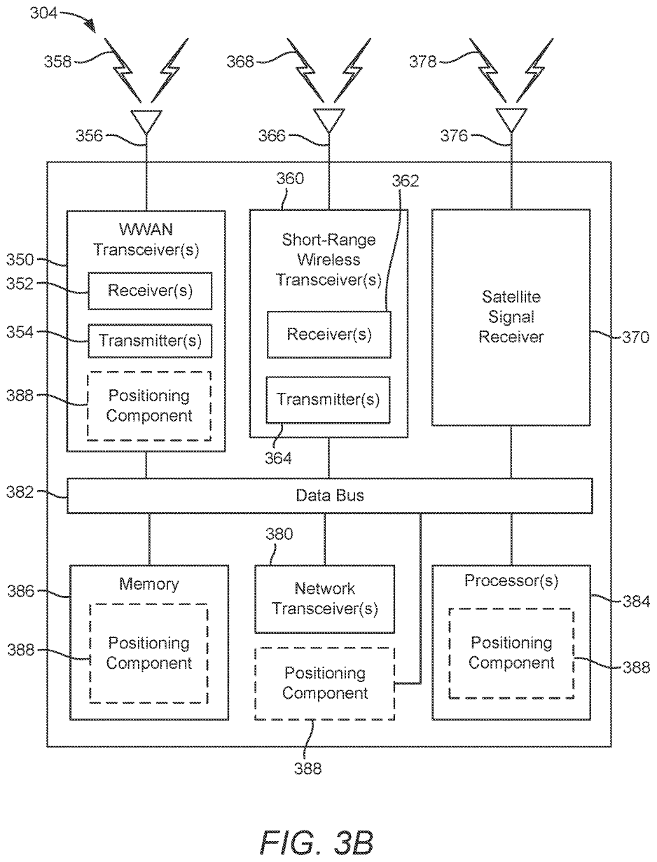

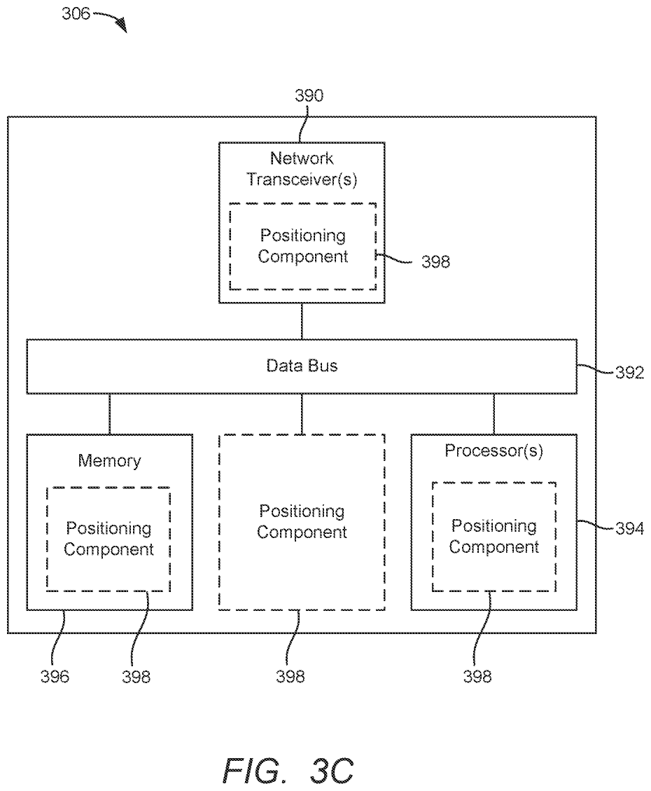

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

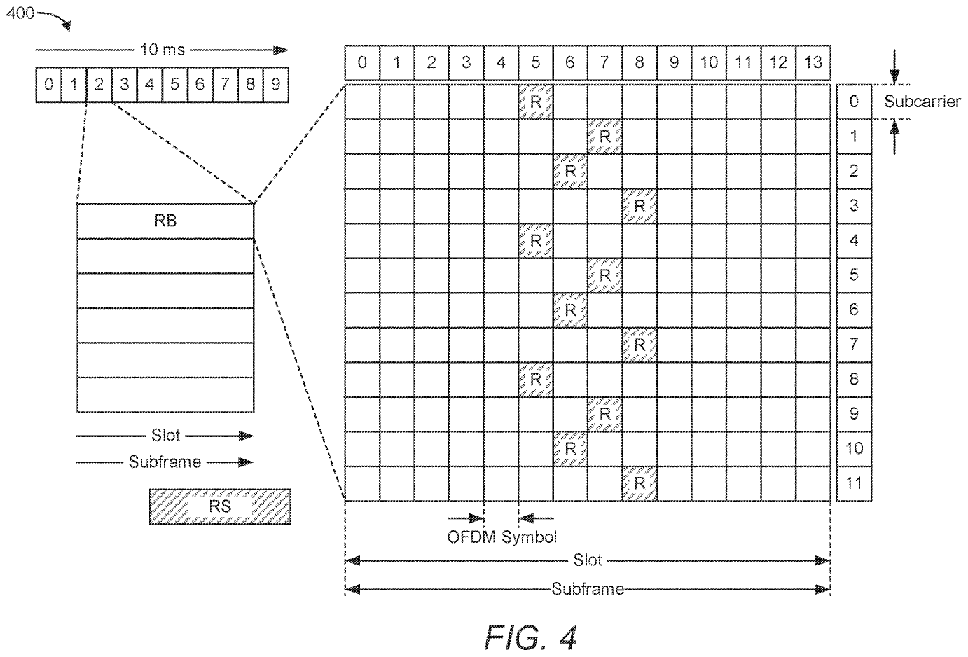

FIG. 4 is a diagram 400 illustrating an example frame structure, according to aspects of the disclosure. The frame structure may be a downlink or uplink frame structure. Other wireless communications technologies may have different frame structures and/or different channels. Various frame structures may be used to support downlink and uplink transmissions between network nodes (e.g., base stations and UEs).

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.8 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

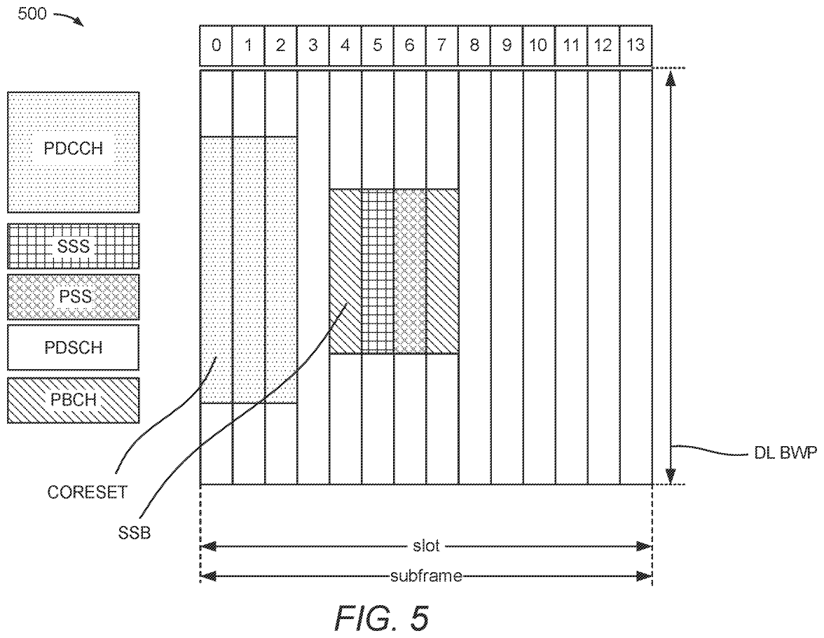

FIG. 5 is a diagram 500 illustrating various downlink channels within an example downlink slot. In FIG. 5, time is represented horizontally (on the X axis) with time increasing from left to right, while frequency is represented vertically (on the Y axis) with frequency increasing (or decreasing) from bottom to top. In the example of FIG. 5, a numerology of 15 kHz is used. Thus, in the time domain, the illustrated slot is one millisecond (ms) in length, divided into 14 symbols.

In NR, the channel bandwidth, or system bandwidth, is divided into multiple bandwidth parts (BWPs). A BWP is a contiguous set of RBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 5, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries a master information block (MIB), may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 5, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 5 is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DCI indicates the resources scheduled for the downlink data channel (e.g., PDSCH) and the uplink data channel (e.g., physical uplink shared channel (PUSCH)). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

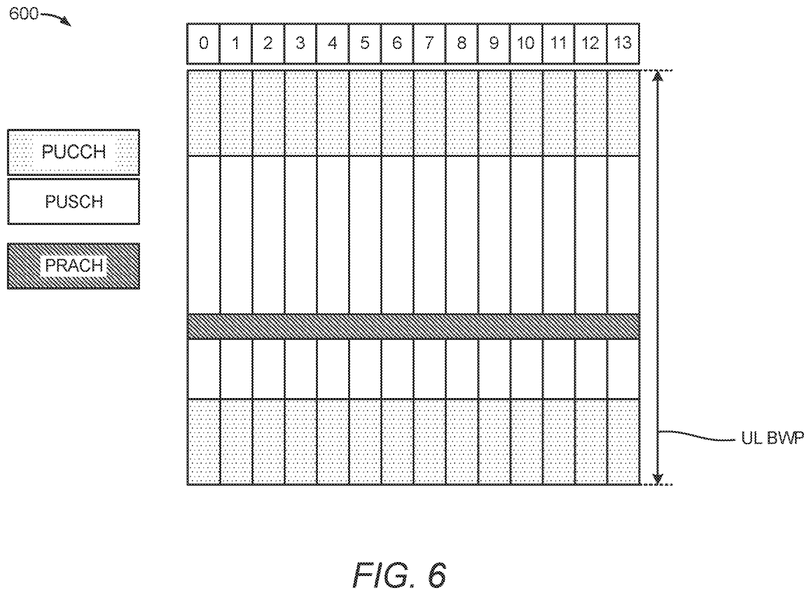

FIG. 6 is a diagram 600 illustrating various uplink channels within an example uplink slot. In FIG. 6, time is represented horizontally (on the X axis) with time increasing from left to right, while frequency is represented vertically (on the Y axis) with frequency increasing (or decreasing) from bottom to top. In the example of FIG. 6, a numerology of 15 kHz is used. Thus, in the time domain, the illustrated slot is one millisecond (ms) in length, divided into 14 symbols.

A random-access channel (RACH), also referred to as a physical random-access channel (PRACH), may be within one or more slots within a frame based on the PRACH configuration. The PRACH may include six consecutive RB pairs within a slot. The PRACH allows the UE to perform initial system access and achieve uplink synchronization. A physical uplink control channel (PUCCH) may be located on edges of the uplink system bandwidth. The PUCCH carries uplink control information (UCI), such as scheduling requests, CSI reports, a channel quality indicator (CQI), a precoding matrix indicator (PMI), a rank indicator (RI), and HARQ ACK/NACK feedback. The physical uplink shared channel (PUSCH) carries data, and may additionally be used to carry a buffer status report (BSR), a power headroom report (PHR), and/or UCI.

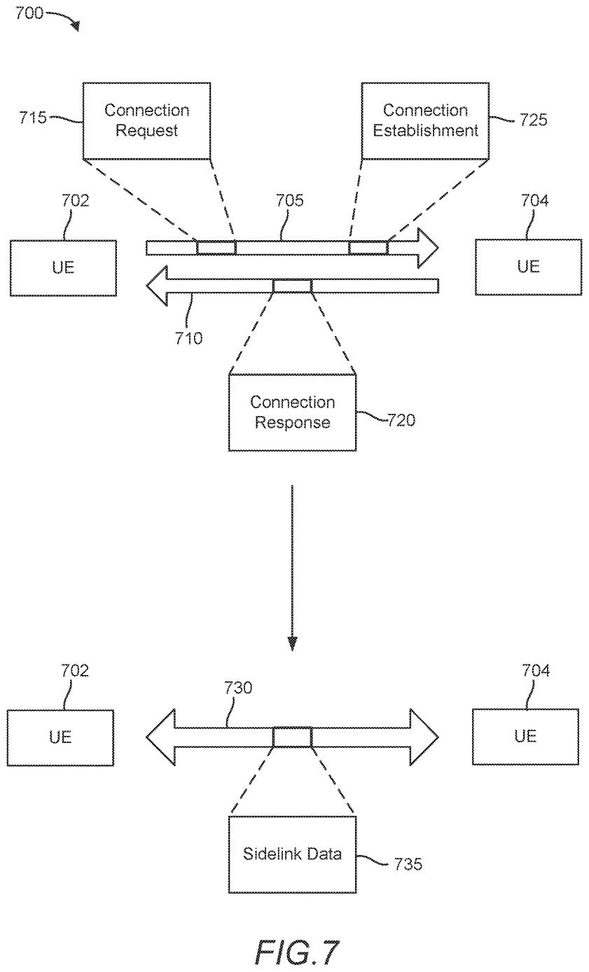

FIG. 7 illustrates an example of a wireless communications system 700 that supports wireless unicast sidelink establishment, according to aspects of the disclosure. In some examples, wireless communications system 700 may implement aspects of wireless communications systems 100, 200, and 250. Wireless communications system 700 may include a first UE 702 and a second UE 704, which may be examples of any of the UEs described herein. As specific examples, UEs 702 and 704 may correspond to V-UEs 160 in FIG. 1.

In the example of FIG. 7, the UE 702 may attempt to establish a unicast connection over a sidelink with the UE 704, which may be a V2X sidelink between the UE 702 and UE 704. As specific examples, the established sidelink connection may correspond to sidelinks 162 and/or 168 in FIG. 1. The sidelink connection may be established in an omni-directional frequency range (e.g., FR1) and/or a mmW frequency range (e.g., FR2). In some cases, the UE 702 may be referred to as an initiating UE that initiates the sidelink connection procedure, and the UE 704 may be referred to as a target UE that is targeted for the sidelink connection procedure by the initiating UE.

For establishing the unicast connection, access stratum (AS) (a functional layer in the UMTS and LTE protocol stacks between the RAN and the UE that is responsible for transporting data over wireless links and managing radio resources, and which is part of Layer 2) parameters may be configured and negotiated between the UE 702 and UE 704. For example, a transmission and reception capability matching may be negotiated between the UE 702 and UE 704. Each UE may have different capabilities (e.g., transmission and reception, 64 quadrature amplitude modulation (QAM), transmission diversity, carrier aggregation (CA), supported communications frequency band(s), etc.). In some cases, different services may be supported at the upper layers of corresponding protocol stacks for UE 702 and UE 704. Additionally, a security association may be established between UE 702 and UE 704 for the unicast connection. Unicast traffic may benefit from security protection at a link level (e.g., integrity protection). Security requirements may differ for different wireless communications systems. For example, V2X and Uu systems may have different security requirements (e.g., Uu security does not include confidentiality protection). Additionally, IP configurations (e.g., IP versions, addresses, etc.) may be negotiated for the unicast connection between UE 702 and UE 704.

In some cases, UE 704 may create a service announcement (e.g., a service capability message) to transmit over a cellular network (e.g., cV2X) to assist the sidelink connection establishment. Conventionally, UE 702 may identify and locate candidates for sidelink communications based on a basic service message (BSM) broadcasted unencrypted by nearby UEs (e.g., UE 704). The BSM may include location information, security and identity information, and vehicle information (e.g., speed, maneuver, size, etc.) for the corresponding UE. However, for different wireless communications systems (e.g., D2D or V2X communications), a discovery channel may not be configured so that UE 702 is able to detect the BSM(s). Accordingly, the service announcement transmitted by UE 704 and other nearby UEs (e.g., a discovery signal) may be an upper layer signal and broadcasted (e.g., in an NR sidelink broadcast). In some cases, the UE 704 may include one or more parameters for itself in the service announcement, including connection parameters and/or capabilities it possesses. The UE 702 may then monitor for and receive the broadcasted service announcement to identify potential UEs for corresponding sidelink connections. In some cases, the UE 702 may identify the potential UEs based on the capabilities each UE indicates in their respective service announcements.

The service announcement may include information to assist the UE 702 (e.g., or any initiating UE) to identify the UE transmitting the service announcement (UE 704 in the example of FIG. 7). For example, the service announcement may include channel information where direct communication requests may be sent. In some cases, the channel information may be RAT-specific (e.g., specific to LTE or NR) and may include a resource pool within which UE 702 transmits the communication request. Additionally, the service announcement may include a specific destination address for the UE (e.g., a Layer 2 destination address) if the destination address is different from the current address (e.g., the address of the streaming provider or UE transmitting the service announcement). The service announcement may also include a network or transport layer for the UE 702 to transmit a communication request on. For example, the network layer (also referred to as “Layer 3” or “L3”) or the transport layer (also referred to as “Layer 4” or “L4”) may indicate a port number of an application for the UE transmitting the service announcement. In some cases, no IP addressing may be needed if the signaling (e.g., PC5 signaling) carries a protocol (e.g., a real-time transport protocol (RTP)) directly or gives a locally-generated random protocol. Additionally, the service announcement may include a type of protocol for credential establishment and QoS-related parameters.

After identifying a potential sidelink connection target (UE 704 in the example of FIG. 7), the initiating UE (UE 702 in the example of FIG. 7) may transmit a connection request 715 to the identified target UE 704. In some cases, the connection request 715 may be a first RRC message transmitted by the UE 702 to request a unicast connection with the UE 704 (e.g., an “RRCSetupRequest” message). For example, the unicast connection may utilize the PC5 interface for the sidelink, and the connection request 715 may be an RRC connection setup request message. Additionally, the UE 702 may use a sidelink signaling radio bearer 705 to transport the connection request 715.

After receiving the connection request 715, the UE 704 may determine whether to accept or reject the connection request 715. The UE 704 may base this determination on a transmission/reception capability, an ability to accommodate the unicast connection over the sidelink, a particular service indicated for the unicast connection, the contents to be transmitted over the unicast connection, or a combination thereof. For example, if the UE 702 wants to use a first RAT to transmit or receive data, but the UE 704 does not support the first RAT, then the UE 704 may reject the connection request 715. Additionally or alternatively, the UE 704 may reject the connection request 715 based on being unable to accommodate the unicast connection over the sidelink due to limited radio resources, a scheduling issue, etc. Accordingly, the UE 704 may transmit an indication of whether the request is accepted or rejected in a connection response 720. Similar to the UE 702 and the connection request 715, the UE 704 may use a sidelink signaling radio bearer 710 to transport the connection response 720. Additionally, the connection response 720 may be a second RRC message transmitted by the UE 704 in response to the connection request 715 (e.g., an “RRCResponse” message).

In some cases, sidelink signaling radio bearers 705 and 710 may be the same sidelink signaling radio bearer or may be separate sidelink signaling radio bearers. Accordingly, a radio link control (RLC) layer acknowledged mode (AM) may be used for sidelink signaling radio bearers 705 and 710. A UE that supports the unicast connection may listen on a logical channel associated with the sidelink signaling radio bearers. In some cases, the AS layer (i.e., Layer 2) may pass information directly through RRC signaling (e.g., control plane) instead of a V2X layer (e.g., data plane).

If the connection response 720 indicates that the UE 704 accepted the connection request 715, the UE 702 may then transmit a connection establishment 725 message on the sidelink signaling radio bearer 705 to indicate that the unicast connection setup is complete. In some cases, the connection establishment 725 may be a third RRC message (e.g., an “RRCSetupComplete” message). Each of the connection request 715, the connection response 720, and the connection establishment 725 may use a basic capability when being transported from one UE to the other UE to enable each UE to be able to receive and decode the corresponding transmission (e.g., the RRC messages).

Additionally, identifiers may be used for each of the connection request 715, the connection response 720, and the connection establishment 725. For example, the identifiers may indicate which UE 702/704 is transmitting which message and/or for which UE 702/704 the message is intended. For physical (PHY) layer channels, the RRC signaling and any subsequent data transmissions may use the same identifier (e.g., Layer 2 IDs). However, for logical channels, the identifiers may be separate for the RRC signaling and for the data transmissions. For example, on the logical channels, the RRC signaling and the data transmissions may be treated differently and have different acknowledgement (ACK) feedback messaging. In some cases, for the RRC messaging, a physical layer ACK may be used for ensuring the corresponding messages are transmitted and received properly.

One or more information elements may be included in the connection request 715 and/or the connection response 720 for UE 702 and/or UE 704, respectively, to enable negotiation of corresponding AS layer parameters for the unicast connection. For example, the UE 702 and/or UE 704 may include packet data convergence protocol (PDCP) parameters in a corresponding unicast connection setup message to set a PDCP context for the unicast connection. In some cases, the PDCP context may indicate whether or not PDCP duplication is utilized for the unicast connection. Additionally, the UE 702 and/or UE 704 may include RLC parameters when establishing the unicast connection to set an RLC context for the unicast connection. For example, the RLC context may indicate whether an AM (e.g., a reordering timer (t-reordering) is used) or an unacknowledged mode (UM) is used for the RLC layer of the unicast communications.

Additionally, the UE 702 and/or UE 704 may include medium access control (MAC) parameters to set a MAC context for the unicast connection. In some cases, the MAC context may enable resource selection algorithms, a hybrid automatic repeat request (HARQ) feedback scheme (e.g., ACK or negative ACK (NACK) feedback), parameters for the HARQ feedback scheme, carrier aggregation, or a combination thereof for the unicast connection. Additionally, the UE 702 and/or UE 704 may include PHY layer parameters when establishing the unicast connection to set a PHY layer context for the unicast connection. For example, the PHY layer context may indicate a transmission format (unless transmission profiles are included for each UE 702/704) and a radio resource configuration (e.g., bandwidth part (BWP), numerology, etc.) for the unicast connection. These information elements may be supported for different frequency range configurations (e.g., FR1 and FR2).

In some cases, a security context may also be set for the unicast connection (e.g., after the connection establishment 725 message is transmitted). Before a security association (e.g., security context) is established between the UE 702 and UE 704, the sidelink signaling radio bearers 705 and 710 may not be protected. After a security association is established, the sidelink signaling radio bearers 705 and 710 may be protected. Accordingly, the security context may enable secure data transmissions over the unicast connection and the sidelink signaling radio bearers 705 and 710. Additionally, IP layer parameters (e.g., link-local IPv4 or IPv6 addresses) may also be negotiated. In some cases, the IP layer parameters may be negotiated by an upper layer control protocol running after RRC signaling is established (e.g., the unicast connection is established). As noted above, the UE 704 may base its decision on whether to accept or reject the connection request 715 on a particular service indicated for the unicast connection and/or the contents to be transmitted over the unicast connection (e.g., upper layer information). The particular service and/or contents may be also indicated by an upper layer control protocol running after RRC signaling is established.

After the unicast connection is established, the UE 702 and UE 704 may communicate using the unicast connection over a sidelink 730, where sidelink data 735 is transmitted between the two UEs 702 and 704. The sidelink 730 may correspond to sidelinks 162 and/or 168 in FIG. 1. In some cases, the sidelink data 735 may include RRC messages transmitted between the two UEs 702 and 704. To maintain this unicast connection on sidelink 730, UE 702 and/or UE 704 may transmit a keep alive message (e.g., “RRCLinkAlive” message, a fourth RRC message, etc.). In some cases, the keep alive message may be triggered periodically or on-demand (e.g., event-triggered). Accordingly, the triggering and transmission of the keep alive message may be invoked by UE 702 or by both UE 702 and UE 704. Additionally or alternatively, a MAC control element (CE) (e.g., defined over sidelink 730) may be used to monitor the status of the unicast connection on sidelink 730 and maintain the connection. When the unicast connection is no longer needed (e.g., UE 702 travels far enough away from UE 704), either UE 702 and/or UE 704 may start a release procedure to drop the unicast connection over sidelink 730. Accordingly, subsequent RRC messages may not be transmitted between UE 702 and UE 704 on the unicast connection.

A UE that is within or part of a vehicle may be referred to as a vehicular UE (VUE). A VUE may broadcast its position using a basic safety message (BSM) that advertises the VUE's type, location, and motion state, or using a sensor data sharing message (SDSM). Other VUEs in the vicinity can receive the BSM and determine the location of the sending VUE, and by extension, the location of the vehicle, by reading the location information from the BSM. This allows other VUEs to determine the locations of other nearby VUEs without having to perform time-consuming ranging operations.

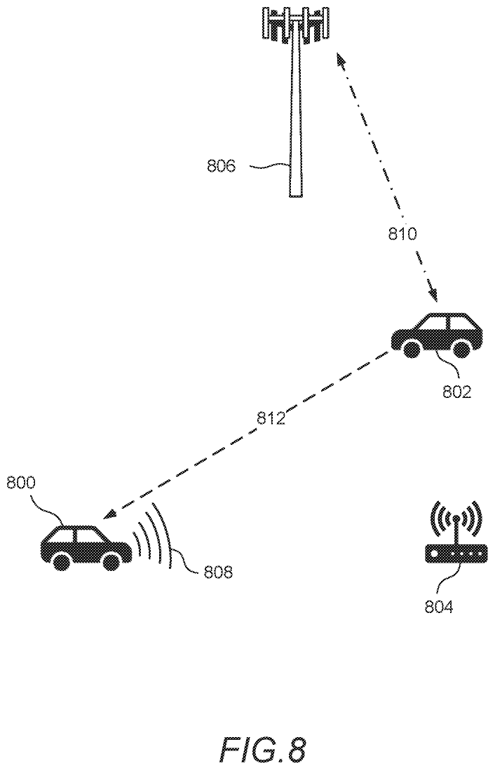

However, there is the possibility that the VUE's actual location is different from the location that the VUE advertises in the BSM that is transmitted. This may happen, for example, as a result of component failure of a sensor, GPS transceiver, etc., or other accidental cause, or may be a deliberate goal of a malicious application or malware. An example of this is illustrated in FIG. 8.

FIG. 8 illustrates possible interactions between wireless devices, according to aspects of the disclosure. FIG. 8 illustrates interactions between a VUE1 800, a VUE2 802, an access point 804, and a third entity 806, which may be a roadside unit (RSU) or base station (BS). In FIG. 8, one of the wireless devices may be able to detect that there is a discrepancy between the advertised position of another wireless device and the actual position of that other wireless device.

For example, VUE1 800 may report is position in a BSM 808. A VUE2 802 or AP 804 receives the BSM 808 that contains the advertised position or VUE1 800, and calculates the distance between its own position and the advertised position of VUE1 800. VUE2 802 or AP 804 then knows the distance from VUE1 800 and knows the advertised transmit power of the BSM 808, and can therefore calculate what the expected received signal strength indicator (RSSI) value should be for the BSM 808.

If the actual RSSI value of the BSM 808 is different from the expected value of the RSSI, then this suggests that the presumed distance between VUE1 800 and VUE2 802 (or between VUE1 800 and AP 804) may be incorrect, which may be because the advertised position of VUE1 800 is incorrect. In this scenario, VUE2 802 or AP 804 may request confirmation of the position of the VUE1 800 from a network server 806. This request is shown in FIG. 8 as signaling 810 from VUE2 802. In addition, the VUE2 802 or AP 804 may notify the VUE1 800 and/or the network of the discrepancy. This notification is shown in FIG. 8 as message 812 from VUE2 802. In some aspects, VUE2 802 or AP 804 may issue something called a “misbehavior report”, but that report is sent to a “misbehavior authority” such as the federal communications commission (FCC), which oversees GPS.

In another example, AP 804 may advertise its position and one of the other wireless devices may determine that the advertised position of AP 804 does not match its actual position. There are scenarios where APs and other non-mobile devices are unaware of their true positions. For example, AP 804 may be an indoor AP that was originally installed for communication purposes, but is now being repurposed to act as an anchor node for the sake of providing positioning services to other wireless devices. Many such APs rely on crowdsourcing (where they make measurements with several UEs over time) to come up with a position estimate. Another scenario is where the measured ground truth of an AP is itself erroneous, due to human error and calibration errors. Yet another scenario is when a stationary AP is relocated or redeployed for some reason. As such, these estimates may be erroneous, and the techniques disclosed herein can help an AP, such as AP 804 in FIG. 8, identify and correct an error in its own position estimate.

However, there is currently no provision in the 3GPP specifications for extending “discrepancy detection” to include crowdsourcing. Accordingly, techniques for position accuracy improvements through crowdsourcing are now presented. These techniques may include crowdsourcing of misbehavior notification, identification of specific measurements and/or positioning anchor points as being questionable or potential sources of error, and identifying and circumventing security vulnerabilities.

### Misbehavior Notification Through Crowdsourcing

In some aspects, positioning accuracy improvements through crowdsourcing may involve sharing of discrepancy information among multiple nodes, which may be VUEs, RSUs, network entities, etc. Using VUE1 and VUE2 as an example, VUE1 reports its own position in a BSM or SDSM. In some aspects, VUE1 may also report the list of measurements upon which its own position calculation was based. In some aspects, VUE1 may also provide information on the anchor locations and specific technologies that were used to estimate its own position. In this example, VUE2 receives all of the information reported or provided by VUE1, and determines that there is a discrepancy between the position of VUE1 as reported by VUE1 and the position of VUE1 as determined from sources other than VUE1's self-reported position.

In some aspects, VUE2 may report the discrepancy via an extension of BSM or SDSM, or via a new message. In some aspects, VUE2 provides an explanation of why it considers the position reported by VUE1 to be in error, a list of measurements upon which VUE2 based that conclusion, or both. In some aspects, VUE2 may also provide a confidence value for its conclusion, e.g., how certain or uncertain VUE2 is that the position reported by VUE1 is wrong. In some aspects, VUE2 may identify a specific positioning anchor as one that may be leading to the erroneous positioning estimate. For example, VUE2 may determine or detect that the specific positioning anchor is reporting an incorrect ground truth. In some aspects, VUE2 may detect that the specific positioning anchor may be a source of error by observing that various target nodes that use the specific positioning anchor as a common anchor node all have perceived erroneous position estimates.

### Reaction to the Misbehavior Notification

When VUE1 receives a warning, e.g., from VUE2 that VUE1's reported position may be incorrect, VUE1 may respond in a number of ways. In some aspects, VUE1 may simply ignore the warning from VUE2. In some aspects, VUE1 may ignore the warning from VUE2 until a threshold number of other VUEs also send the same or similar warning. In some aspects, VUE1 may perform additional measurements with other VUEs to confirm, validate, or verify that VUE2's warning is correct. In some aspects, VUE1 may choose to validate VUE2's warning using only a subset of devices of the same make and/or model or belonging a certain group of devices that have been authenticated by VUE1 for performing such validation. In some aspects, the details of such a group, e.g., its membership list, may be stored on a server, and can be requested by VUE1 on-demand. These techniques of confirming or validating a warning from one source (e.g., VUE2) by comparing its findings with those from other sources (e.g., VUE3, VUE4, etc.) may prevent VUE1 from being misled or spoofed by bad information from VUE2. This provides enhanced security against potential spoofing attacks by one or a small number of malicious VUEs.

In some aspects, such as when the warning from VUE2 identifies sources that VUE2 determines might be incorrect or unreliable, VUE1 may remove those sources from VUE1's position calculations. In some aspects, removing a source may trigger VUE1 to recalculate its position without the suspect source and issue another BSM with updated location information.

In some aspects, VUE1 may respond to VUE2. For example, in some aspects, VUE1 may notify VUE2 that VUE1 is ignoring the warning from VUE2. In some aspects, VUE1 may indicate to VUE2 that VUE2's warning is unjustified. For example, VUE1 may provide VUE2 with a list of devices that have not sent similar warning (e.g., to let VUE2 know that VUE2 may be wrong in its assessment). In some aspects, VUE1 may notify VUE2 that VUE1 has confirmed that VUE2's warning is correct. In some aspects, VUE1 may notify VUE2 that VUE1 will now ignore some specific positioning sources, which may or may not be the same as the sources that VUE2 suspected to be incorrect or unreliable.

### Selective Reporting or Filtering of Crowdsourcing Data

In some aspects, positioning accuracy improvements through crowdsourcing may involve using a third party moderator to vet, filter, and/or report the crowdsourced data. In some aspects, a dedicated device or devices may be deployed to identify good crowdsourcing data, which is then broadcast to the rest of the network. In some aspects, these devices may be deployed at known locations. In some aspects, these devices may be proprietary servers, such as a connected intelligent edge (CIE), for example. In some aspects, these devices may passively listen to measurement exchanges between VUEs, for example, and in turn may maintain a list of devices and measurements that are considered to be “good” (which help make accurate position estimates). In some aspects, these devices may also proactively perform positioning measurements with other VUEs, and then gather good crowdsourcing data after performing misbehavior detection.

In some aspects, these devices may then broadcast/multicast the good crowdsourcing data (that contains valid measurements) to other target nodes seeking to validate their existing position estimate, or to enhance the accuracy of their existing position estimate. In some aspects, these devices may also include information about sources of error, such as anchors with incorrect ground truth, so that other target devices may exclude measurements made with such anchor nodes, from their final position estimation calculation. In some aspects, these devices may relay information to a network entity, which in turn broadcasts the crowdsourced data. In some aspects, this data may be region-specific, e.g., it may be broadcast only to target devices within a particular region.

Crowdsourcing Measurement-Fusion Weights from Various Devices

In some aspects, positioning accuracy improvements through crowdsourcing may involve crowdsourcing measurement-fusion weights from various devices. In some aspects, a device may broadcast the set of weights that it is applying to various sources, e.g., in an SDSM message, a vehicle to anything (V2X) message, another type of message, or a new message. In some aspects, when a first device detects a discrepancy by another device, the first device may adjust the weight(s) associated with that other device, and broadcast this adjustment to neighboring devices so that they, too, can make this weight adjustment. Likewise, the first device may notify a server of this adjustment, and the server may notify other devices of this adjustment, e.g., via sending updated assistance data.

In some aspects, a device of certain make/model may be utilizing certain strategies in terms of the way measurements are combined to obtain a position estimate. In some aspects, the fusion process may be abstracted to a set of weights that apply across different types of measurements and technologies. In some aspects, the device may broadcast or multicast this information to neighboring devices, along with make/model details. In some aspects, through misbehavior detection, the receiving device may be able to learn appropriate weighting schemes that improve the positioning accuracy of the transmitting device; these weights may be relayed to a network entity, such as a location server or LMF, or a proprietary server, such as a CIE. In some aspects, the server can record and maintain a table of such data which in turn can be used as assistance data in future positioning sessions. In some aspects, the assistance data may be in the form of an appropriate weighting scheme across measurements and technologies. In some aspects, the assistance data could also vary from region-to-region. For instance, a coarse region may be defined as an area in downtown as opposed to another area along the highway, and so on. In some aspects, such information may be exchanged between devices that operate under a subscription service, or belong to a certain class of devices of a certain make/model/operating system.

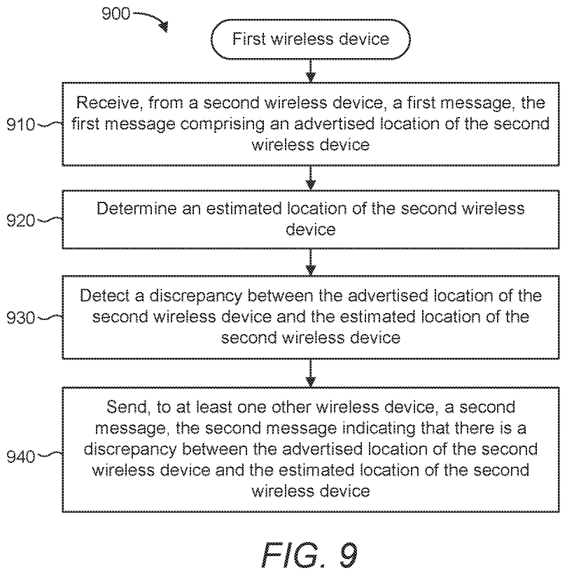

FIG. 9 is a flowchart of an example process 900 associated with position accuracy improvements through crowdsourcing, according to aspects of the disclosure. In some implementations, one or more process blocks of FIG. 9 may be performed by a first wireless device (e.g., UE 104, AP 150). In some implementations, one or more process blocks of FIG. 9 may be performed by another device or a group of devices separate from or including the UE. Additionally, or alternatively, one or more process blocks of FIG. 9 may be performed by one or more components of UE 302, such as processor(s) 332, memory 340, WWAN transceiver(s) 310, short-range wireless transceiver(s) 320, satellite signal receiver 330, sensor(s) 344, user interface 346, and positioning component(s) 342, any or all of which may be means for performing the operations of process 900.

As shown in FIG. 9, process 900 may include receiving, from a second UE, a first message, the first message comprising an advertised location of the second UE (block 910). Means for performing the operation of block 910 may include the processor(s) 332, memory 340, or WWAN transceiver(s) 310 of the UE 302. For example, the UE 302 may receive the first message using the receiver(s) 312.

As further shown in FIG. 9, process 900 may include determining an estimated location of the second UE (block 920). Means for performing the operation of block 920 may include the processor(s) 332, memory 340, or WWAN transceiver(s) 310 of the UE 302. For example, the UE 302 may determine an estimated location of the second UE based on analysis of the first message by the processor(s) 332.

As further shown in FIG. 9, process 900 may include detecting a discrepancy between the advertised location of the second UE and the estimated location of the second UE (block 930). Means for performing the operation of block 930 may include the processor(s) 332, memory 340, or WWAN transceiver(s) 310 of the UE 302. For example, the UE 302 may detect a discrepancy between the advertised location of the second UE and the estimated location of the second UE, using the processor(s) 332.

As further shown in FIG. 9, process 900 may include sending, to at least one other UE, a second message, the second message indicating that there is a discrepancy between the advertised location of the second UE and the estimated location of the second UE (block 940). Means for performing the operation of block 940 may include the processor(s) 332, memory 340, or WWAN transceiver(s) 310 of the UE 302. For example, the UE 302 may send the second message using the transmitter(s) 314.

In some aspects, receiving the first message comprises receiving a basic safety message (BSM) or a sensor data sharing message (SDSM).

In some aspects, determining the estimated location of the second UE comprises determining the estimated location of the second UE based on a positioning operation involving the second UE.

In some aspects, determining the estimated location of the second UE comprises receiving an indication of the estimated location of the second UE from another UE, a base station, or a network entity.

In some aspects, the first message includes an indication of a transmitted power and is received at a received power, and wherein determining an estimated location of the second UE comprises calculating a first estimated distance between the first UE and the second UE based on a difference between the transmitted power of the first message and the received power of the first message.

In some aspects, detecting the discrepancy between the advertised location of the second UE and the estimated location of the second UE comprises calculating a second estimated distance between the first UE and the second UE based on the advertised location of the first UE and a current location of the second UE, and detecting that the first estimated distance and the second estimated distance do not match.

In some aspects, reporting that there is a discrepancy between the advertised location of the second UE and the estimated location of the second UE to the at least one UE comprises reporting the discrepancy to the second UE.

In some aspects, reporting that there is a discrepancy between the advertised location of the second UE and the estimated location of the second UE to the at least one UE comprises at least one of reporting the advertised location of the second UE and the estimated location of the second UE, indicating the method used to determine the estimated location, indicating a confidence value in an accuracy of the estimated location, or identifying at least one positioning anchor point as a potential source or cause of the discrepancy.

In some aspects, sending the second message to at least one other UE comprises sending the second message via a third entity that collects, filters, or aggregates messages.

Process 900 may include additional implementations, such as any single implementation or any combination of implementations described below and/or in connection with one or more other processes described elsewhere herein. Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

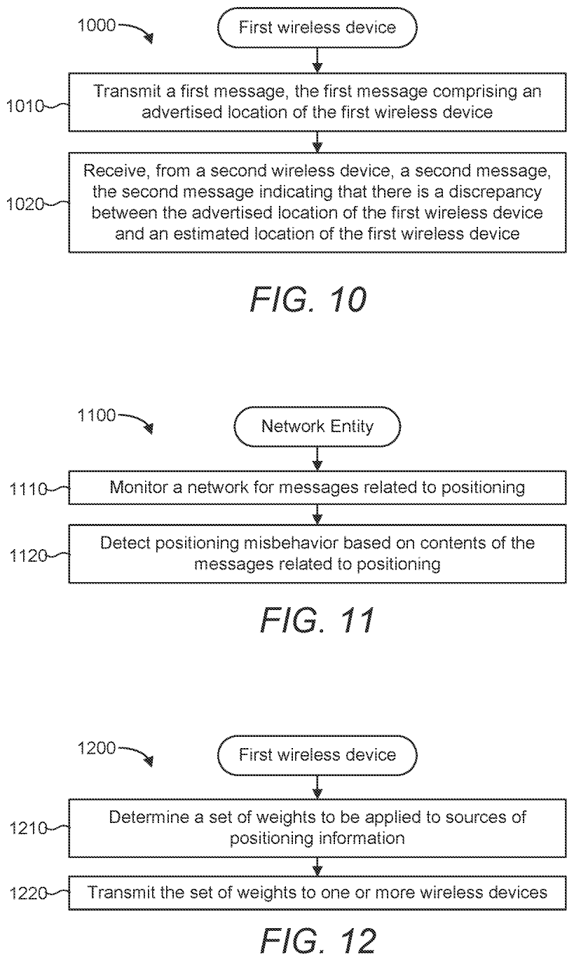

FIG. 10 is a flowchart of an example process 1000 associated with position accuracy improvements through crowdsourcing, according to aspects of the disclosure. In some implementations, one or more process blocks of FIG. 10 may be performed by a UE (e.g., UE 104, AP 150). In some implementations, one or more process blocks of FIG. 10 may be performed by another device or a group of devices separate from or including the UE. Additionally, or alternatively, one or more process blocks of FIG. 10 may be performed by one or more components of UE 302, such as processor(s) 332, memory 340, WWAN transceiver(s) 310, short-range wireless transceiver(s) 320, satellite signal receiver 330, sensor(s) 344, user interface 346, and positioning component(s) 342, any or all of which may be means for performing the operations of process 1000.

As shown in FIG. 10, process 1000 may include transmitting a first message, the first message comprising an advertised location of the first UE (block 1010). Means for performing the operation of block 1010 may include the processor(s) 332, memory 340, or WWAN transceiver(s) 310 of the UE 302. For example, the UE 302 may transmit the first message using the transmitter(s) 314.

As further shown in FIG. 10, process 1000 may include receiving, from a second UE, a second message, the second message indicating that there is a discrepancy between the advertised location of the first UE and an estimated location of the first UE (block 1020). Means for performing the operation of block 1020 may include the processor(s) 332, memory 340, or WWAN transceiver(s) 310 of the UE 302. For example, the UE 302 may receive the second message using the receiver(s) 312.

In some aspects, process 1000 includes verifying an accuracy of the advertised location of the first UE.

In some aspects, verifying the accuracy of the advertised location of the first UE comprises performing a positioning operation to determine a current position of the first UE and comparing the advertised location of the first UE to the current position of the first UE.

In some aspects, upon determining that the advertised location of the first UE was accurate, the first UE may notify the second UE that the advertised location of the first UE was accurate, and upon determining that the advertised location of the first UE was not accurate, the first UE may notify the second UE that the advertised location of the first UE was not accurate.

In some aspects, upon determining that the advertised location of the first UE was not accurate, the first UE may perform a positioning operation to determine a current position of the first UE, and may transmit a third message, the third message comprising the current position of the first UE as the advertised location of the first UE.

In some aspects, the first UE may opt to not verify an accuracy of the advertised location of the first UE unless a threshold number of other UEs indicate or have indicated that there is a discrepancy between the advertised location of the first UE and an estimated location of the first UE.

In some aspects, the second message comprises information that identifies at least one positioning anchor point as a potential source or cause of the discrepancy, and wherein the method further comprises excluding the at least one positioning anchor point from positioning operations.

In some aspects, the first UE may transmit, to the second UE, a list of other UEs that have not indicated to the first UE that there is a discrepancy between the advertised location of the first UE and an estimated location of the first UE.

In some aspects, receiving the second message comprises receiving the second message from the second UE via a third entity that collects, filters, or aggregates messages.

Process 1000 may include additional implementations, such as any single implementation or any combination of implementations described below and/or in connection with one or more other processes described elsewhere herein. Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a flowchart of an example process 1100 associated with position accuracy improvements through crowdsourcing, according to aspects of the disclosure. In some implementations, one or more process blocks of FIG. 11 may be performed by a network entity (e.g., location server 172, a custom server, a CIE). In some implementations, one or more process blocks of FIG. 11 may be performed by another device or a group of devices separate from or including the network entity. Additionally, or alternatively, one or more process blocks of FIG. 11 may be performed by one or more components of network entity 306, such as processor(s) 394, memory 396, network transceiver(s) 390, and positioning component(s) 398, any or all of which may be means for performing the operations of process 1100.

As shown in FIG. 11, process 1100 may include monitoring a network for messages related to positioning (block 1110). Means for performing the operation of block 1110 may include the processor(s) 394, memory 396, or network transceiver(s) 390 of the network entity 306. For example, the network entity 306 may monitor a network for messages related to positioning, using the network transceiver(s).

As further shown in FIG. 11, process 1100 may include detecting positioning misbehavior based on contents of the messages related to positioning (block 1120). Means for performing the operation of block 1120 may include the processor(s) 394, memory 396, or network transceiver(s) 390 of the network entity 306. For example, the network entity 306 may detect positioning misbehavior based on contents of the messages related to positioning, using the processor(s) 394 and memory 396.

In some aspects, the process 1100 may include initiating positioning operations with at least one network device, wherein monitoring the network for messages related to positioning comprises monitoring the network for messages related to the positioning operations that were initiated by the network entity.

In some aspects, detecting positioning misbehavior comprises identifying a first set of network devices that are potential sources or causes of positioning errors, identifying a second set of network devices that are not potential sources or causes of positioning error, or identifying both the first set and the second set.

In some aspects, identifying the first set of network devices that are potential sources or causes of positioning errors comprises identifying a network device that receives notifications of a discrepancy between an advertised location of the network device and an estimated location of the network device, or identifying a network device that is involved in one or more positioning operations that resulted in a notification of a discrepancy between an advertised location of the network device and an estimated location of the network device.

In some aspects, identifying the first set of network devices that are potential sources or causes of positioning errors comprises receiving, from network devices, messages identifying one or more network devices that are potential sources or causes of positioning errors.

In some aspects, process 1100 may include transmitting a message that identifies the first set of network devices, the second set of network devices, or both.

In some aspects, process 1100 may include transmitting positioning information from messages related to positioning for which no positioning misbehavior was detected.

Process 1100 may include additional implementations, such as any single implementation or any combination of implementations described below and/or in connection with one or more other processes described elsewhere herein. Although FIG. 11 shows example blocks of process 1100, in some implementations, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a flowchart of an example process 1200 associated with position accuracy improvements through crowdsourcing, according to aspects of the disclosure. In some implementations, one or more process blocks of FIG. 12 may be performed by a wireless device (e.g., UE 104, AP 150). In some implementations, one or more process blocks of FIG. 12 may be performed by another device or a group of devices separate from or including the UE. Additionally, or alternatively, one or more process blocks of FIG. 12 may be performed by one or more components of UE 302, such as processor(s) 332, memory 340, WWAN transceiver(s) 310, short-range wireless transceiver(s) 320, satellite signal receiver 330, sensor(s) 344, user interface 346, and positioning component(s) 342, any or all of which may be means for performing the operations of process 1200.

As shown in FIG. 12, process 1200 may include determining a set of weights to be applied to sources of positioning information (block 1210). Means for performing the operation of block 1210 may include the processor(s) 332, memory 340, or WWAN transceiver(s) 310 of the UE 302. For example, the UE 302 may determine a set of weights to be applied to sources of positioning information, using the processor(s) 332.

As further shown in FIG. 12, process 1200 may include transmitting the set of weights to one or more other UEs (block 1220). Means for performing the operation of block 1220 may include the processor(s) 332, memory 340, or WWAN transceiver(s) 310 of the UE 302. For example, the UE 302 may transmit the set of weights to one or more other UEs, using the transmitter(s).

In some aspects, determining the set of weights to be applied to sources of positioning information comprises receiving the set of weights as assistance data.

In some aspects, transmitting the set of weights to the one or more other UEs comprises transmitting the set of weights in a sensor data sharing message (SDSM) or a vehicle-to-anything (V2X) message.

In some aspects, transmitting the set of weights to the one or more other UEs comprises transmitting the set of weights to a server that will transmit the set of weights to the one or more other UEs.

In some aspects, process 1200 includes receiving, information identifying a first source of positioning information as being a possible cause or source of positioning errors, updating a weight to be applied to the first source of positioning information, and transmitting an updated set of weights to the one or more other UEs.

Process 1200 may include additional implementations, such as any single implementation or any combination of implementations described below and/or in connection with one or more other processes described elsewhere herein. Although FIG. 12 shows example blocks of process 1200, in some implementations, process 1200 may include additional blocks, fewer blocks, different blocks, or differently arranged blocks than those depicted in FIG. 12. Additionally, or alternatively, two or more of the blocks of process 1200 may be performed in parallel.

As will be appreciated, a technical advantage of the methods described herein is that crowdsourcing provides a larger wealth of data from which to draw inferences about possible sources of positioning error and provides mechanisms by which network devices can directly benefit from this wealth of data. Benefits include, but are not limited to, being able to identify positioning misbehavior and either correct or mitigate such behavior, and validating a positioning estimate in a secure manner, e.g., by potentially carrying out the validation with a trusted group of other devices.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a first wireless device, the method comprising: receiving, from a second wireless device, a first message, the first message comprising an advertised location of the second wireless device; determining an estimated location of the second wireless device; detecting a discrepancy between the advertised location of the second wireless device and the estimated location of the second wireless device; and sending, to at least one other wireless device, a second message, the second message indicating that there is a discrepancy between the advertised location of the second wireless device and the estimated location of the second wireless device.

Clause 2. The method of clause 1, wherein receiving the first message comprises receiving a basic safety message (BSM) or a sensor data sharing message (SDSM).

Clause 3. The method of any of clauses 1 to 2, wherein determining the estimated location of the second wireless device comprises determining the estimated location of the second wireless device based on a positioning operation involving the second wireless device.

Clause 4. The method of any of clauses 1 to 3, wherein determining the estimated location of the second wireless device comprises receiving an indication of the estimated location of the second wireless device from another wireless device, a base station, or a network entity.

Clause 5. The method of any of clauses 1 to 4, wherein the first message includes an indication of a transmitted power and is received at a received power, and wherein determining an estimated location of the second wireless device comprises calculating a first estimated distance between the first wireless device and the second wireless device based on a difference between the transmitted power of the first message and the received power of the first message.

Clause 6. The method of clause 5, wherein detecting the discrepancy between the advertised location of the second wireless device and the estimated location of the second wireless device comprises: calculating a second estimated distance between the first wireless device and the second wireless device based on the advertised location of the first wireless device and a current location of the second wireless device; and detecting that the first estimated distance and the second estimated distance do not match.

Clause 7. The method of any of clauses 1 to 6, wherein reporting that there is a discrepancy between the advertised location of the second wireless device and the estimated location of the second wireless device to the at least one wireless device comprises reporting the discrepancy to the second wireless device.

Clause 8. The method of any of clauses 1 to 7, wherein reporting that there is a discrepancy between the advertised location of the second wireless device and the estimated location of the second wireless device to the at least one wireless device comprises at least one of: reporting the advertised location of the second wireless device and the estimated location of the second wireless device; indicating the method used to determine the estimated location; indicating a confidence value in an accuracy of the estimated location; or identifying at least one positioning anchor point as a potential source or cause of the discrepancy.

Clause 9. The method of any of clauses 1 to 8, wherein sending the second message to at least one other wireless device comprises sending the second message via a third entity that collects, filters, or aggregates messages.

Clause 10. A method of wireless communication performed by a first wireless device, the method comprising: transmitting a first message, the first message comprising an advertised location of the first wireless device; and receiving, from a second wireless device, a second message, the second message indicating that there is a discrepancy between the advertised location of the first wireless device and an estimated location of the first wireless device.

Clause 11. The method of clause 10, further comprising verifying an accuracy of the advertised location of the first wireless device.

Clause 12. The method of clause 11, wherein verifying the accuracy of the advertised location of the first wireless device comprises performing a positioning operation to determine a current position of the first wireless device and comparing the advertised location of the first wireless device to the current position of the first wireless device.

Clause 13. The method of any of clauses 11 to 12, further comprising: upon determining that the advertised location of the first wireless device was accurate, notifying the second wireless device that the advertised location of the first wireless device was accurate; and upon determining that the advertised location of the first wireless device was not accurate, notifying the second wireless device that the advertised location of the first wireless device was not accurate.

Clause 14. The method of any of clauses 11 to 13, wherein, upon determining that the advertised location of the first wireless device was not accurate, performing a positioning operation to determine a current position of the first wireless device, and transmitting a third message, the third message comprising the current position of the first wireless device as the advertised location of the first wireless device.

Clause 15. The method of any of clauses 10 to 14, further comprising not verifying an accuracy of the advertised location of the first wireless device unless a threshold number of other wireless devices indicate or have indicated that there is a discrepancy between the advertised location of the first wireless device and an estimated location of the first wireless device.

Clause 16. The method of any of clauses 10 to 15, wherein the second message comprises information that identifies at least one positioning anchor point as a potential source or cause of the discrepancy, and wherein the method further comprises excluding the at least one positioning anchor point from positioning operations.

Clause 17. The method of any of clauses 10 to 16, further comprising transmitting, to the second wireless device, a list of other wireless devices that have not indicated to the first wireless device that there is a discrepancy between the advertised location of the first wireless device and an estimated location of the first wireless device.

Clause 18. The method of any of clauses 10 to 17, wherein receiving the second message comprises receiving the second message from the second wireless device via a third entity that collects, filters, or aggregates messages.

Clause 19. A method of wireless communication performed by a network entity, the method comprising: monitoring a network for messages related to positioning; and detecting positioning misbehavior based on contents of the messages related to positioning.

Clause 20. The method of clause 19, further comprising initiating positioning operations with at least one network device, wherein monitoring the network for messages related to positioning comprises monitoring the network for messages related to the positioning operations that were initiated by the network entity.

Clause 21. The method of any of clauses 19 to 20, wherein detecting positioning misbehavior comprises identifying a first set of network devices that are potential sources or causes of positioning errors, identifying a second set of network devices that are not potential sources or causes of positioning error, or identifying both the first set and the second set.

Clause 22. The method of clause 21, wherein identifying the first set of network devices that are potential sources or causes of positioning errors comprises: identifying a network device that receives notifications of a discrepancy between an advertised location of the network device and an estimated location of the network device; or identifying a network device that is involved in one or more positioning operations that resulted in a notification of a discrepancy between an advertised location of the network device and an estimated location of the network device.

Clause 23. The method of any of clauses 21 to 22, wherein identifying the first set of network devices that are potential sources or causes of positioning errors comprises receiving, from network devices, messages identifying one or more network devices that are potential sources or causes of positioning errors.

Clause 24. The method of any of clauses 21 to 23, further comprising transmitting a message that identifies the first set of network devices, the second set of network devices, or both.

Clause 25. The method of any of clauses 19 to 24, further comprising transmitting positioning information from messages related to positioning for which no positioning misbehavior was detected.

Clause 26. A method of wireless communication performed by a wireless device, the method comprising: determining a set of weights to be applied to sources of positioning information; and transmitting the set of weights to one or more other wireless devices.

Clause 27. The method of clause 26, wherein determining the set of weights to be applied to sources of positioning information comprises receiving the set of weights as assistance data.

Clause 28. The method of any of clauses 26 to 27, wherein transmitting the set of weights to the one or more other wireless devices comprises transmitting the set of weights in a sensor data sharing message (SDSM) or a vehicle-to-anything (V2X) message.

Clause 29. The method of any of clauses 26 to 28, wherein transmitting the set of weights to the one or more other wireless devices comprises transmitting the set of weights to a server that will transmit the set of weights to the one or more other wireless devices.

Clause 30. The method of any of clauses 26 to 29, further comprising: receiving, information identifying a first source of positioning information as being a possible cause or source of positioning errors; updating a weight to be applied to the first source of positioning information; and transmitting an updated set of weights to the one or more other wireless devices.

Clause 31. A first wireless device, comprising: a memory; at least one transceiver; and at least one processor communicatively coupled to the memory and the at least one transceiver, the at least one processor configured to: receive, via the at least one transceiver from a second wireless device, a first message, the first message comprising an advertised location of the second wireless device; determine an estimated location of the second wireless device; detect a discrepancy between the advertised location of the second wireless device and the estimated location of the second wireless device; and send, via the at least one transceiver, to at least one other wireless device, a second message, the second message indicating that there is a discrepancy between the advertised location of the second wireless device and the estimated location of the second wireless device.

Clause 32. The first wireless device of clause 31, wherein, to receive the first message, the at least one processor is configured to receive a basic safety message (BSM) or a sensor data sharing message (SDSM).

Clause 33. The first wireless device of any of clauses 31 to 32, wherein, to determine the estimated location of the second wireless device, the at least one processor is configured to determine the estimated location of the second wireless device based on a positioning operation involving the second wireless device.

Clause 34. The first wireless device of any of clauses 31 to 33, wherein, to determine the estimated location of the second wireless device, the at least one processor is configured to receive an indication of the estimated location of the second wireless device from another wireless device, a base station, or a network entity.

Clause 35. The first wireless device of any of clauses 31 to 34, wherein the first message includes an indication of a transmitted power and is received at a received power, and wherein determining an estimated location of the second wireless device comprises calculating a first estimated distance between the first wireless device and the second wireless device based on a difference between the transmitted power of the first message and the received power of the first message.

Clause 36. The first wireless device of clause 35, wherein, to detect the discrepancy between the advertised location of the second wireless device and the estimated location of the second wireless device, the at least one processor is configured to: calculate a second estimated distance between the first wireless device and the second wireless device based on the advertised location of the first wireless device and a current location of the second wireless device; and detect that the first estimated distance and the second estimated distance do not match.

Clause 37. The first wireless device of any of clauses 31 to 36, wherein, to report that there is a discrepancy between the advertised location of the second wireless device and the estimated location of the second wireless device to the at least one wireless device, the at least one processor is configured to report the discrepancy to the second wireless device.

Clause 38. The first wireless device of any of clauses 31 to 37, wherein, to report that there is a discrepancy between the advertised location of the second wireless device and the estimated location of the second wireless device to the at least one wireless device, the at least one processor is configured to: report the advertised location of the second wireless device and the estimated location of the second wireless device; indicate the method used to determine the estimated location; indicate a confidence value in an accuracy of the estimated location; or identify at least one positioning anchor point as a potential source or cause of the discrepancy.

Clause 39. The first wireless device of any of clauses 31 to 38, wherein, to send the second message to at least one other wireless device, the at least one processor is configured to send the second message via a third entity that collects, filters, or aggregates messages.

Clause 40. A first wireless device, comprising: a memory; at least one transceiver, and at least one processor communicatively coupled to the memory and the at least one transceiver, the at least one processor configured to: transmit, via the at least one transceiver, a first message, the first message comprising an advertised location of the first wireless device; and receive, via the at least one transceiver from a second wireless device, a second message, the second message indicating that there is a discrepancy between the advertised location of the first wireless device and an estimated location of the first wireless device.

Clause 41. The first wireless device of clause 40, wherein the at least one processor is further configured to verify an accuracy of the advertised location of the first wireless device.

Clause 42. The first wireless device of clause 41, wherein, to verify the accuracy of the advertised location of the first wireless device, the at least one processor is configured to perform a positioning operation to determine a current position of the first wireless device and comparing the advertised location of the first wireless device to the current position of the first wireless device.

Clause 43. The first wireless device of any of clauses 41 to 42, wherein the at least one processor is further configured to: upon determining that the advertised location of the first wireless device was accurate, notifying the second wireless device that the advertised location of the first wireless device was accurate; and upon determining that the advertised location of the first wireless device was not accurate, notifying the second wireless device that the advertised location of the first wireless device was not accurate.

Clause 44. The first wireless device of any of clauses 41 to 43, wherein, upon determining that the advertised location of the first wireless device was not accurate, performing a positioning operation to determine a current position of the first wireless device, and transmitting a third message, the third message comprising the current position of the first wireless device as the advertised location of the first wireless device.

Clause 45. The first wireless device of any of clauses 40 to 44, wherein the at least one processor is further configured to not verifying an accuracy of the advertised location of the first wireless device unless a threshold number of other wireless devices indicate or have indicated that there is a discrepancy between the advertised location of the first wireless device and an estimated location of the first wireless device.

Clause 46. The first wireless device of any of clauses 40 to 45, wherein the second message comprises information that identifies at least one positioning anchor point as a potential source or cause of the discrepancy, and wherein the method further comprises excluding the at least one positioning anchor point from positioning operations.

Clause 47. The first wireless device of any of clauses 40 to 46, wherein the at least one processor is further configured to transmit, via the at least one transceiver, to the second wireless device, a list of other wireless devices that have not indicated to the first wireless device that there is a discrepancy between the advertised location of the first wireless device and an estimated location of the first wireless device.

Clause 48. The first wireless device of any of clauses 40 to 47, wherein, to receive the second message, the at least one processor is configured to receive the second message from the second wireless device via a third entity that collects, filters, or aggregates messages.

Clause 49. A network entity, comprising: a memory; at least one transceiver; and at least one processor communicatively coupled to the memory and the at least one transceiver, the at least one processor configured to: monitor a network for messages related to positioning; and detect positioning misbehavior based on contents of the messages related to positioning.

Clause 50. The network entity of clause 49, wherein the at least one processor is further configured to initiate positioning operations with at least one network device, wherein monitoring the network for messages related to positioning comprises monitoring the network for messages related to the positioning operations that were initiated by the network entity.

Clause 51. The network entity of any of clauses 49 to 50, wherein, to detect positioning misbehavior, the at least one processor is configured to identify a first set of network devices that are potential sources or causes of positioning errors, identifying a second set of network devices that are not potential sources or causes of positioning error, or identifying both the first set and the second set.

Clause 52. The network entity of clause 51, wherein, to identify the first set of network devices that are potential sources or causes of positioning errors, the at least one processor is configured to: identify a network device that receives notifications of a discrepancy between an advertised location of the network device and an estimated location of the network device; or identify a network device that is involved in one or more positioning operations that resulted in a notification of a discrepancy between an advertised location of the network device and an estimated location of the network device.

Clause 53. The network entity of any of clauses 51 to 52, wherein, to identify the first set of network devices that are potential sources or causes of positioning errors, the at least one processor is configured to receive, from network devices, messages identifying one or more network devices that are potential sources or causes of positioning errors.

Clause 54. The network entity of any of clauses 51 to 53, wherein the at least one processor is further configured to transmit, via the at least one transceiver, a message that identifies the first set of network devices, the second set of network devices, or both.

Clause 55. The network entity of any of clauses 49 to 54, wherein the at least one processor is further configured to transmit, via the at least one transceiver, positioning information from messages related to positioning for which no positioning misbehavior was detected.

Clause 56. A wireless device, comprising: a memory; at least one transceiver; and at least one processor communicatively coupled to the memory and the at least one transceiver, the at least one processor configured to: determine a set of weights to be applied to sources of positioning information; and transmit, via the at least one transceiver, the set of weights to one or more other wireless devices.

Clause 57. The wireless device of clause 56, wherein, to determine the set of weights to be applied to sources of positioning information, the at least one processor is configured to receive the set of weights as assistance data.

Clause 58. The wireless device of any of clauses 56 to 57, wherein, to transmit the set of weights to the one or more other wireless devices, the at least one processor is configured to transmit the set of weights in a sensor data sharing message (SDSM) or a vehicle-to-anything (V2X) message.

Clause 59. The wireless device of any of clauses 56 to 58, wherein, to transmit the set of weights to the one or more other wireless devices, the at least one processor is configured to transmit the set of weights to a server that will transmit the set of weights to the one or more other wireless devices.

Clause 60. The wireless device of any of clauses 56 to 59, wherein the at least one processor is further configured to: receive, via the at least one transceiver, information identifying a first source of positioning information as being a possible cause or source of positioning errors; update a weight to be applied to the first source of positioning information; and transmit, via the at least one transceiver, an updated set of weights to the one or more other wireless devices.

Clause 61. An apparatus comprising a memory, a transceiver, and a processor communicatively coupled to the memory and the transceiver, the memory, the transceiver, and the processor configured to perform a method according to any of clauses 1 to 30.

Clause 62. An apparatus comprising means for performing a method according to any of clauses 1 to 30.

Clause 63. A non-transitory computer-readable medium storing computer-executable instructions, the computer-executable comprising at least one instruction for causing a computer or processor to perform a method according to any of clauses 1 to 30.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of wireless communication performed by a first wireless device, the method comprising:
receiving, from a second wireless device, a first message, the first message comprising an advertised location of the second wireless device;
determining an estimated location of the second wireless device;
detecting a discrepancy between the advertised location of the second wireless device and the estimated location of the second wireless device; and
sending, to at least one other wireless device, a second message, the second message indicating that there is a discrepancy between the advertised location of the second wireless device and the estimated location of the second wireless device.

2. The method of claim 1, wherein receiving the first message comprises receiving a basic safety message (BSM) or a sensor data sharing message (SDSM).

3. The method of claim 1, wherein determining the estimated location of the second wireless device comprises determining the estimated location of the second wireless device based on a positioning operation involving the second wireless device.

4. The method of claim 1, wherein determining the estimated location of the second wireless device comprises receiving an indication of the estimated location of the second wireless device from another wireless device, a base station, or a network entity.

5. The method of claim 1, wherein the first message includes an indication of a transmitted power and is received at a received power, and wherein determining an estimated location of the second wireless device comprises calculating a first estimated distance between the first wireless device and the second wireless device based on a difference between the transmitted power of the first message and the received power of the first message.

6. The method of claim 5, wherein detecting the discrepancy between the advertised location of the second wireless device and the estimated location of the second wireless device comprises:
calculating a second estimated distance between the first wireless device and the second wireless device based on the advertised location of the first wireless device and a current location of the second wireless device; and
detecting that the first estimated distance and the second estimated distance do not match.

7. The method of claim 1, wherein reporting that there is a discrepancy between the advertised location of the second wireless device and the estimated location of the second wireless device to the at least one wireless device comprises reporting the discrepancy to the second wireless device.

8. The method of claim 1, wherein reporting that there is a discrepancy between the advertised location of the second wireless device and the estimated location of the second wireless device to the at least one wireless device comprises at least one of: reporting the advertised location of the second wireless device and the estimated location of the second wireless device;
indicating the method used to determine the estimated location;
indicating a confidence value in an accuracy of the estimated location; or identifying at least one positioning anchor point as a potential source or cause of the discrepancy.

9. The method of claim 1, wherein sending the second message to at least one other wireless device comprises sending the second message via a third entity that collects, filters, or aggregates messages.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. A first wireless device, comprising
a memory;
at least one transceiver; and
at least one processor communicatively coupled to the memory and the at least one transceiver, the at least one processor configured to:
receive, via the at least one transceiver from a second wireless device, a first message, the first message comprising an advertised location of the second wireless device;
determine an estimated location of the second wireless device; detect a discrepancy between the advertised location of the second wireless device and the estimated location of the second wireless device; and send, via the at least one transceiver, to at least one other wireless device, a second message, the second message indicating that there is a discrepancy between the advertised location of the second wireless device and the estimated location of the second wireless device.

32. The first wireless device of claim 31, wherein, to receive the first message, the at least one processor is configured to receive a basic safety message (BSM) or a sensor data sharing message (SDSM).

33. The first wireless device of claim 31, wherein, to determine the estimated location of the second wireless device, the at least one processor is configured to determine the estimated location of the second wireless device based on a positioning operation involving the second wireless device, or receive an indication of the estimated location of the second wireless device from another wireless device, a base station, or a network entity.

34. The first wireless device of claim 31, wherein the first message includes an indication of a transmitted power and is received at a received power, and wherein determining an estimated location of the second wireless device comprises calculating a first estimated distance between the first wireless device and the second wireless device based on a difference between the transmitted power of the first message and the received power of the first message.

35. A first wireless device, comprising:
a memory;
at least one transceiver; and
at least one processor communicatively coupled to the memory and the at least one transceiver, the at least one processor configured to:
transmit, via the at least one transceiver, a first message, the first message comprising an advertised location of the first wireless device; and receive, via the at least one transceiver from a second wireless device, a second message, the second message indicating that there is a discrepancy between the advertised location of the first wireless device and an estimated location of the first wireless device.

36. The first wireless device of claim 35, wherein the at least one processor is further configured to verify an accuracy of the advertised location of the first wireless device.

37. The first wireless device of claim 35, wherein the at least one processor is further configured to not verify an accuracy of the advertised location of the first wireless device unless a threshold number of other wireless devices indicate or have indicated that there is a discrepancy between the advertised location of the first wireless device and an estimated location of the first wireless device.

38. The first wireless device of claim 35, wherein the second message comprises information that identifies at least one positioning anchor point as a potential source or cause of the discrepancy, and wherein the method further comprises excluding the at least one positioning anchor point from positioning operations.

39. (canceled)

40. (canceled)

41. (canceled)

42. (canceled)

43. (canceled)

44. (canceled)

45. (canceled)
